(19) United States
(12) Patent Application Publication
(10) Pub. No.: US 2015/0372434 A1
(43) Pub. Date: Dec. 24, 2015

(54) Power Supply Plug Adapter

(71) Applicants: Jeffrey Lyons, Newberry, FL (US); Giacomo Strollo, San Diego, CA (US); Del Ray Doty, Carlsbad, CA (US)

(72) Inventors: Jeffrey Lyons, Newberry, FL (US); Giacomo Strollo, San Diego, CA (US); Del Ray Doty, Carlsbad, CA (US)

(73) Assignee: Jeffrey Lyons, Newberry, FL (US)

(21) Appl. No.: 14/313,189

(22) Filed: Jun. 24, 2014

(51) Int. Cl. H01R 31/02

(52) U.S. Cl. CPC H01R 31/02

(57) ABSTRACT

A computer power supply plug adapter which is comprised of a female cord-end connector at one end, a male cord-end connector in-line with the female cord-end connector at the other end, and a plurality of female AC plug in receptacles at right angles to the female cord-end connector and the male cord end connector in between the female cord-end connector and the male cord-end connector.

### CROSS REFERENCE TO RELATED APPLICATIONS

This is a Continuation in Part of application Ser. No. 29/478,198, Filed Jan. 2, 2014.

### STATEMENT REGARDING FEDERALLY SPONSORED RESEARCH OR DEVELOPMENT

No Federal Funds were involved in the research or development of the present invention.

### DESCRIPTION OF ATTACHED APPENDIX

Not Applicable

### BACKGROUND OF THE INVENTION

Because meetings often take place in rooms with limited AC receptacles, there is a need for a small, convenient device to easily add AC receptacles to an existing laptop or desktop computer. Often travelers have multiple devices and airports, hotels and motels do not have sufficient outlets for them to efficiently work remotely.

Information relevant to attempts to address these and other problems can be found in in the following:

U.S. Pat. No. 5,855,494 (Blaszcyzk et. al.) Jan. 5, 1999, is a very short extension cord which must be plugged into a wall outlet.

U.S. Pat. No. D674,348 S (Lee et. al.) Jan. 15, 2013 is a very large extension cord socket with multiple plug in receptacles.

U.S. Pat. No. D671,496 S (Byrne) Nov. 27, 2012 is a female connector.

U.S. Pat. No. D613,248 S (Wu) Apr. 6, 2010 is a long power cord with a socket inserted in the middle.

U.S. Pat. No. D596,572 S (Wu et al.) Jul. 25, 2009 is an electrical adapter at right angles.

U.S. Pat. No. D552,036 S (Holland) Oct. 2, 2007 and U.S. Pat. No. D548,187 S (Holland) Aug. 7, 2007 and U.S. Pat. No. D538,227 S (Holland) Mar. 13, 2007 are fold away plug adapters.

U.S. Pat. No. Des. 407,372 (Starec et al.) Mar. 30, 1999 and U.S. Pat. No. Des. 360,873 (Starec et al.) Aug. 1, 1995 are multi pin multi socket electrical connectors.

However, each one of these references suffers from one or more of the below described disadvantages and shortcomings.

In an attempt to increase socket numbers, some prior patents have attempted to solve this problem by describing various positions and types of plugs, but to date, none of these prior inventions have been practically successful in solving the problem of a small, unobtrusive, easy to manufacture, pack and easily useable device that can add additional AC plug outlets when using a laptop. This is precisely what the embodiment of the present invention disclosed in this patent provides.

### SUMMARY

The invention is a computer power supply plug adapter comprising a male cord-end connector having live, neutral and ground contacts at the first end, a female cord-end connector at the second end having live, neutral and ground contacts in-line with the male cord-end connector, a mains receptacle, with the mains receptacle being located between the male cord-end connector and the female cord-end connector at right angles to the male cord-end connector and the female cord-end. The mains live conductor, neutral conductor and ground conductor are incorporated into three subassemblies which are then placed into adjacent positions inside the adapter top and bottom housings to form a monolithic unit.

One of the purposes of the invention is to provide one or more standard, 120-volt power receptacles (such as the standard NEMA 5-15R power receptacle) at the point of interface of any device utilizing a power cord end (such as the standard IEC 60320 C5 power cord) and an appliance inlet (such as the standard IEC C6 appliance inlet) so that the female AC receptacle meets the NEMA 5-15R configuration that mates with the North American 3-prong appliance plug, NEMA 5-15P that has a middle prong mains plug ground conductor, a mains plug live conductor, and a mains plug neutral conductor.

It could also provide one or more outlets, depending on how it was implemented. Additional embodiments could be implemented with multiple outlets to position them on opposite sides of the device, thereby nesting the outlets so that any prongs inserted would make the device as compact as possible for a given number of outlets.

Another purpose of the invention is that to provide a side or sides that are flat or have only a single axis of curvature that can be used to label or brand the device, making it useful for marketing purposes and/or the ability to provide safety information to users.

Another purpose of the device is to allow a male end (IEC 60320 C6) and female end (IEC 60320 C5) of the device to be placed in-line between the cord and the power brick of a common power supply so that power is supplied from the power cord to the power brick for an electronic device such as a laptop or desktop computer or other electronic device.

In another embodiment of the device, it can be used where there are no ground conductors and the male and female cord-end connectors are of the IEC 60320 C7/C8 configuration instead of the IEC 60320 C5/C6 configuration, and the mains receptacles are of the two-prong, NEMA 1-15R configuration instead of the three-prong, NEMA 5-15R configuration.

Another advantage of this invention is that it does not change the angle at which the cord and power supply plug into each other.

It is also compatible with plugs that are both straight from the end of the cord and at a right angle to the direction of the cord.

The structure of the device also allows the device to be placed in-line between the existing cord and power supply “brick” without the need for any modifications to the cord or brick.

Another purpose of the invention is to allow the plug to stay in place without the need for any clips or other retaining devices, which integrates it into the power brick and cord unit so that it is always available and not easily lost as a separate device would be.

Another purpose of the invention is to provide one, two, or a plurality of NEMA 5-15R receptacles.

Another advantage of the invention is that in one of the embodiments, two receptacles are positioned on opposite sides of the device to avoid the problem of a large power block (transformer, “wall wart”, power brick) in one receptacle preventing the use of the other receptacle, while also minimizing the size of the device.

Another advantage of the invention is that the prong positioning of the two receptacles are rotated 180 degrees relative to each other, so that the third prong of each receptacle “nests” between the two flat prongs of the opposing receptacle. This allows for a compact shape, minimizing the length and width of the device. This reduces the manufacturing materials costs, and minimizes the weight and physical space occupied by the device, which are both desirable for reducing shipping costs for manufacturers and retailers, as well as for reducing weight and space requirements for users. This advantage is especially important to frequent travelers.

Another advantage of the invention is that in one embodiment, the novel monolithic construction of the conductors, using mirror images to create identical but mirror-image subassemblies and then installing the two mirror image subassemblies inside the interior of the unit, allows manufacturing and assembly costs for the completed monolithic unit comprising the device to be vastly reduced over the current state of the art.

Another advantage of the invention is that it is compatible with common computer power supplies.

This invention has a further advantage in that it does not interfere in any way with the power source receptacle and fits North American 3-prong appliance plug specifications. This is in comparison to a standard 3-way power splitter with one NEMA 5-15P 3-prong plug and three NEMA 5-15R receptacles, which can interfere with the other outlets on a wall plate or power strip.

Another advantage is that the pairs of outlet plugs in the pair adapter can be placed on the plug adapter directly opposite each other, thereby decreasing the space the plug adapter takes.

Other objects and advantages of the present invention will become apparent from the following descriptions, taken in connection with the accompanying drawings, wherein, by way of illustration and example, several alternative embodiments of the present invention are disclosed.

### BRIEF DESCRIPTION OF THE DRAWINGS

The drawings constitute a part of this specification and include exemplary embodiments of the present invention, which may be embodied in various forms. It is to be understood that in some instances various aspects of the embodiment of the present invention may be shown exaggerated or enlarged to facilitate an understanding of the invention.

FIG. 1 is a three quarter perspective view of the plug adapter looking at the top and the female end.

FIG. 2. is a top plan view of the plug adapter.

FIG. 3 is a bottom plan view of the plug adapter.

FIG. 4 is a front side elevation view of the first unused side of the plug adapter.

FIG. 5 is a back side elevation view of the second unused side of the plug adapter.

FIG. 6 is an end side elevation view of the plug adapter looking towards the female cord-end connector end.

FIG. 7 is an end side elevation view of the plug adapter looking towards the male cord-end connector end.

FIG. 8 a three quarter perspective top view of the plug adapter looking at the male end.

FIG. 9 is a perspective partially exploded, subassembly view of the plug adapter.

FIG. 10 is a perspective exploded view of the plug adapter.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

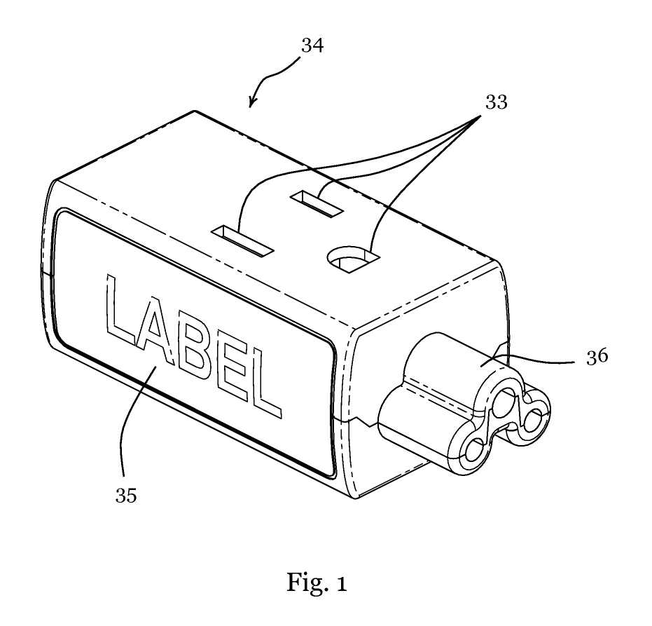

FIG. 1 is a three-quarter perspective view of one embodiment of the plug adapter looking at the top and the female end. The first unused side with a space for a label (35) is shown below the top containing an opening for one three-prong mains receptacle (33) with the standard mains live conductor, neutral conductor, and ground conductor openings showing. The fully assembled plug adapter (34) is shown. Also the female cord-end connector (36) is also visible.

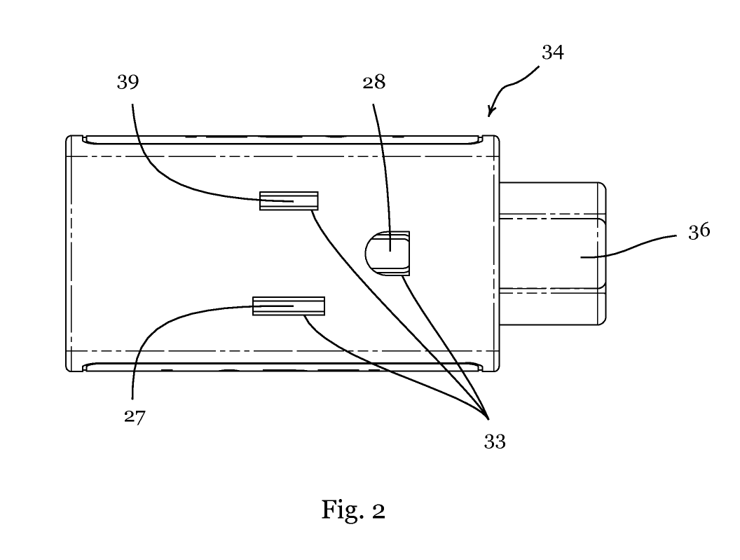

FIG. 2 is a top plan view of one embodiment of the plug adapter. One three-prong mains receptacle (33) comprised of a female receptacle for the mains live conductor (39), a female receptacle for the mains neutral conductor (27), and a female receptacle for the mains ground conductor (28) is visible on the top of the device (34). Also, the female cord-end connector (36) is visible on the side of the device.

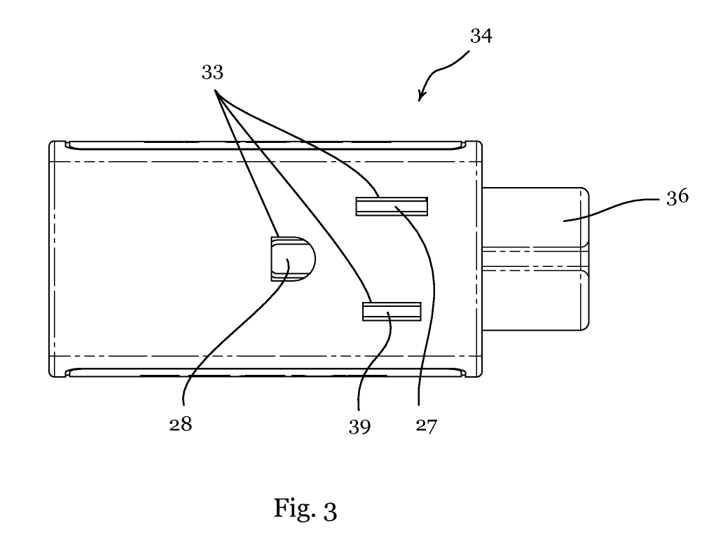

FIG. 3 is a bottom plan view of one embodiment of the plug adapter. Assuming there is already one mains receptacle on the other side, a second three-prong mains receptacle (33) comprised of a female receptacle for the mains ground conductor (28), a female receptacle for the mains neutral conductor (27), and a female receptacle for the mains live conductor (39) are visible on the device (34). Also, the female cord-end connector (36) is visible on the side.

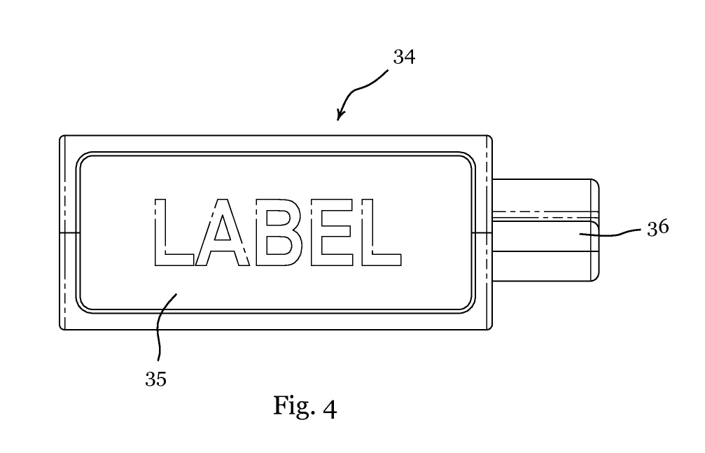

FIG. 4 is a front-side elevation view of the first unused side of one embodiment of the plug adapter. The first unused side with space for a label (35) on the side of the fully assembled plug adapter (34) is visible along with the female cord-end connector (36).

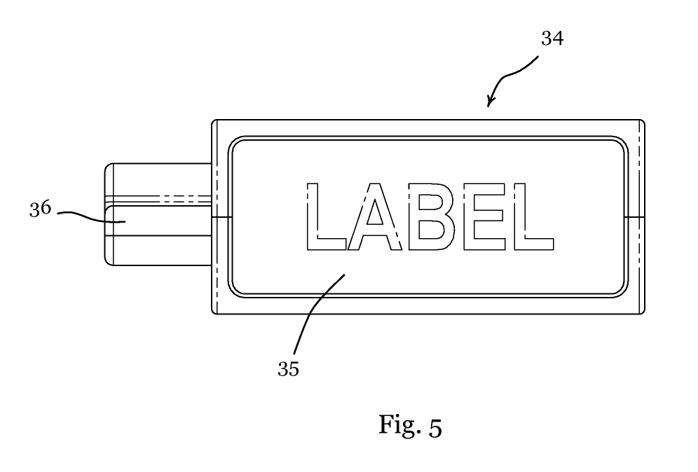

FIG. 5 is a back-side elevation view of one embodiment of the plug adapter showing the second unused side. (Assuming there is a label on the other unused side.) The fully assembled plug adapter (34) is visible showing the second unused side with space for a label (35) and the female cord-end connector is visible on the left (36).

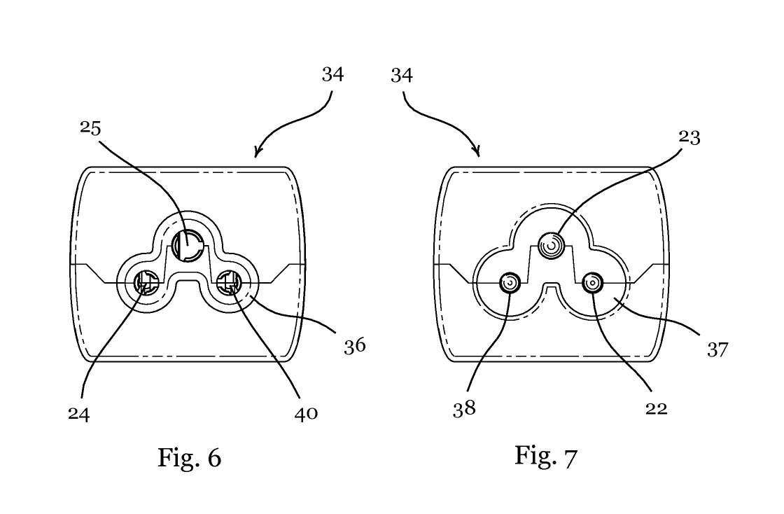

FIG. 6 is an end-side elevation view of one embodiment of the plug adapter looking towards the female cord-end connector end. The end of the assembled adapter (34) is shown with the female cord-end connector ground conductor (25), the female cord-end connector neutral conductor (24), and the female cord-end connector live conductor (40) which are set within the female cord-end connector (36).

FIG. 7 is an end-side elevation view of one embodiment of the plug adapter looking towards the male cord-end connector end. The fully assembled plug adapter (34) is shown at the opposite end of FIG. 6 with the male cord-end connector ground conductor pin (23), the male cord-end connector neutral conductor pin (22), and the male cord-end connector live conductor pin (38) within the male cord-end connector (37).

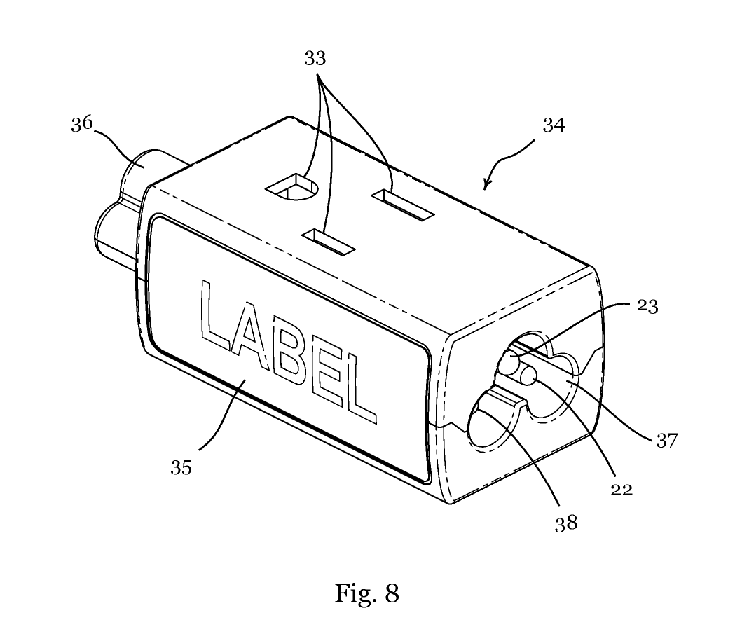

FIG. 8 is a three-quarter perspective top view of one embodiment of the plug adapter looking at the male end. The fully assembled plug adapter (34) shows the three-prong mains receptacle (33) on top, the second unused side with space for a label (35), the male cord-end connector (37) with the male cord-end connector neutral conductor pin (22), the male cord-end connector live conductor pin (38), and the male cord-end connector ground conductor pin (23) inside of the male cord-end connector (37). At the opposite end to the male cord-end connector (37) can be seen the female cord-end connector (36).

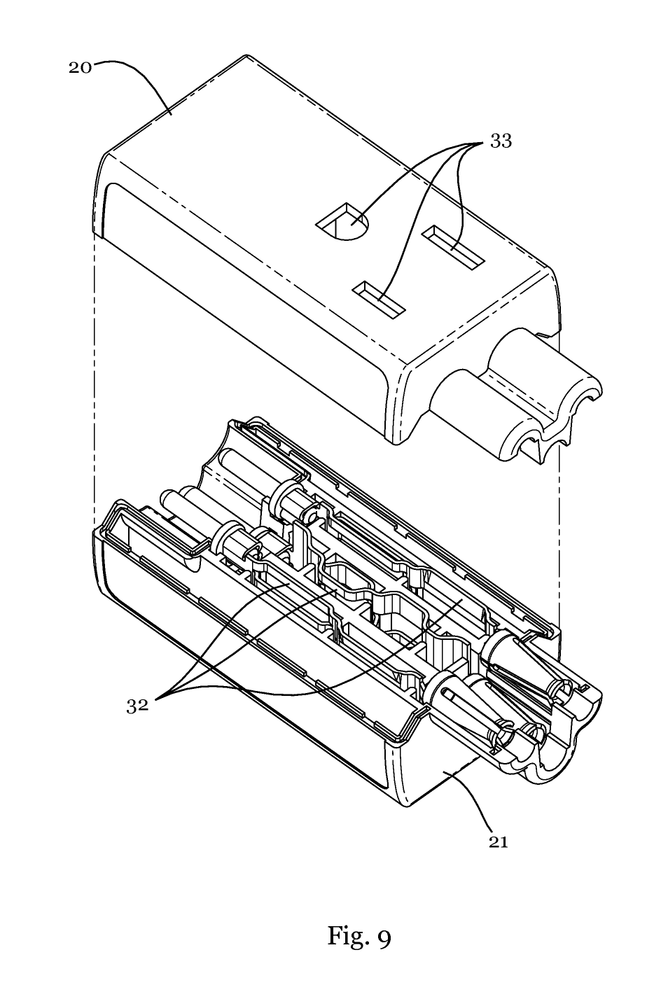

FIG. 9 is a perspective partially exploded, subassembly view of one embodiment of the plug adapter with a monolithic structure. The openings for the three-prong mains receptacle (33) are shown on the adapter bottom housing (20) which, during assembly, is placed on top of the internal subassembly which electrically connects the various legs of connectors with the mains conductors (32) which are shown inserted inside the adapter top housing (21) interior cavity for ease of understanding. In the embodiment shown, the internal subassembly is made up of two subassemblies for the live and neutral conductors and a third subassembly for the ground conductor. The adapter top and bottom housings may both have cavities to hold the subassemblies in them, or one of the housings may have a cavity holding all three subassemblies.

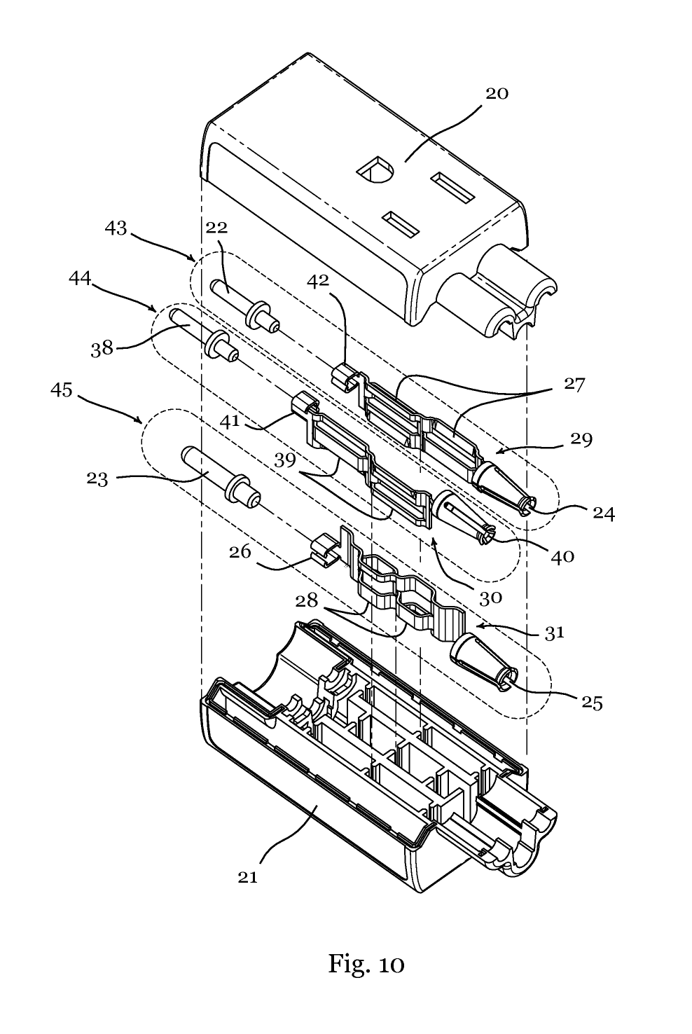

FIG. 10 is a perspective exploded view of the preferred embodiment of the plug adapter showing the adapter top housing (21), the adapter bottom housing (20), and the three conductor subassemblies. The use of these three subassemblies (the neutral conductor subassembly (43), the live conductor subassembly (44) and the ground conductor subassembly (45)) allows the device to be manufactured more easily, less expensively, and more reliably then any existing solution that has been developed yet. The adapter top housing (21) is shown on the bottom as the plug adapter is assembled upside-down. This exploded view shows the male cord-end connector ground conductor pin (23) which is assembled into a ground conductor subassembly (45) by insertion of the male cord-end connector ground conductor pin (23) into the crimp area (26) on the ground conductor springform (31). The ground conductor springform (31) is of monolithic construction and is comprised of female receptacles for the mains ground conductors (28), the female cord-end connector ground conductor (25) and the crimp area on the ground conductor springform (26). For clarity, this entire ground conductor subassembly (45) is comprised of the male cord-end connector ground conductor pin (23) and the ground conductor springform (31). It is placed into cavities inside the adapter top housing (21) between two mirror-image subassemblies: the live conductor subassembly (44) and the neutral conductor subassembly (43). The live conductor subassembly (44) is comprised of a male cord-end connector live conductor pin (38) assembled with a live conductor springform (30) by insertion into the crimp area on the live conductor springform (41). The live conductor springform (31) is of monolithic construction and is comprised of female receptacles for the mains live conductors (39), the female cord-end connector live conductor (40) and the crimp area on the live conductor springform (41). In this embodiment, the neutral conductor subassembly (43) is a mirror image of the live conductor subassembly (44) and is comprised of a male cord-end connector neutral conductor pin (22) assembled with a neutral conductor springform (29) by insertion into the crimp area on the neutral conductor springform (42). The neutral conductor springform (29) is of monolithic construction and is comprised of female receptacles for the mains neutral conductors (27), the female cord-end connector neutral conductor (24) and the crimp area on the neutral conductor springform (42). Each conductor subassembly, the live conductor subassembly (44), the neutral conductor subassembly (43) and the ground conductor subassembly (45), has a female cord-end connector conductor on one side and a male cord-end connector pin on the other end. These mirror image subassemblies, the live conductor subassembly (44) and the neutral conductor subassembly (43) are also placed inside cavities inside the adapter top housing (21) with the ground conductor subassembly (45) being placed between them. These cavities are custom fitted to hold the conductor subassemblies in place using standard injection molding or other similar technology means. The adapter bottom housing (20) with appropriately sized cavities to hold the three subassemblies is then placed on top of the subassemblies making a completed unit compromised of a bottom housing (20), and a top housing (21) with the three subassemblies inside. The entire device is denoted in other figures as (34). It is understood that in the figures, the bottom assembly (20) and the top assembly (21) could be reversed so that the subassemblies could be located in a configuration 180 degrees opposite from the embodiment shown.

While the invention has been described in connection with several embodiments, it is not intended to limit the scope of the invention to the particular forms set forth, but on the contrary, it is intended to cover such alternatives, modifications, and equivalents as may be included within the spirit and scope of the invention as defined by the appended claims.

1. A power supply plug adapter comprising:
a first end and a second end;
a male cord-end connector at the first end, said male cord-end connector being a connector for receiving a power cord;
a female cord-end connector at the second end, said female cord-end connector being a connector for connecting to a laptop power brick;
and
a mains receptacle electrically connected between said first end and said second end for providing power to at least one device having a plug.

2. (canceled)

3. The power supply plug adapter of claim 1 wherein the mains receptacle meets the NEMA 5-15R configuration that mates with a plug having a NEMA 5-15P configuration.

4. The power supply plug adapter of claim 1 further comprising a plurality of mains receptacles located between said first end and said second end.

5. The power supply plug adapter of claim 4 wherein the plurality of mains receptacles are placed in pairs on opposite sides of the plug adapter directly opposite from each other.

6. The power supply plug adapter of claim 5 wherein each of the plurality of mains receptacle have a live conductor, a neutral conductor and a ground conductor and wherein the plurality of mains receptacle pairs are rotated 180 degrees relative to each other, so that the semi-circular hole of each receptacle “nests” between the at least two elongated slots of the receptacle on the opposite side.

7. (canceled)

8. The power supply plug adapter of claim 1 wherein any unused sides of the plug adapter are flat so that there is a first unused side with a space for a label between the male cord-end connector in-line with the female cord-end connector.

9. The power supply plug adapter of claim 8 wherein there is a second unused side of the plug adapter with space for a second label.

10. The power supply plug adapter of claim 9 wherein there are spaces for a plurality of labels on any unused side.

11. The power supply plug adapter of claim 1 wherein any unused sides of the plug adapter have only a single axis of curvature so that there is a first unused side with a space for a label between the male cord-end connector in-line with the female cord-end connector.

12. The power supply plug adapter of claim 11 wherein there is a second unused side of the plug adapter with space for a second label.

13. The power supply plug adapter of claim 12 wherein there are spaces for a plurality of labels on any unused side.

14. A power supply plug adapter comprising:
a first end and a second end;
a male cord-end connector at the first end, said male cord-end connector being a connector for receiving a power cord;
a female cord-end connector at the second end, said female cord-end connector being a connector for connecting to a laptop power brick;
a mains receptacle electrically connected between said first end and said second end for providing power to at least one device having a plug;
an adapter top housing having an interior cavity;
a live conductor subassembly placed inside the interior cavity of the adapter top housing, said live conductor subassembly comprised of
a male cord-end connector live conductor pin;
a live conductor springform having a female cord-end connector live conductor at a live conductor springform first end, a crimp area on the live conductor springform at a live conductor springform second end opposite the live conductor springform first end and a plurality of receptacles that fit mains plug live conductors, the plurality of receptacles being located between the first end and the second end on the live conductor springform;
a neutral conductor subassembly placed inside the interior cavity of the adapter top housing, said neutral conductor subassembly comprised of:
a male cord-end connector neutral conductor pin;
a neutral conductor springform having a female cord-end connector neutral conductor at a neutral conductor springform first end, a crimp area on the neutral conductor springform at a neutral conductor springform second end opposite the neutral conductor springform first end and a plurality of receptacles that fit mains plug neutral conductors, the plurality of receptacles being located between the first end and the second end on the neutral conductor springform;
an adapter bottom housing having an interior cavity; and
the adapter bottom housing being placed under the top housing with the three two subassemblies comprised of the live conductor subassembly and the neutral conductor subassembly inside the cavity making a completed monolithic unit compromised of a bottom housing and a top housing.

15. The power supply plug adapter of claim 14 wherein the live conductor subassembly and neutral conductor subassemblies are not mirror images of each other.

16. The power supply plug adapter of claim 14 wherein the mains receptacles are of a two-prong configuration.

17. The power supply plug adapter of claim 14 wherein the male and female cord-end connectors are IEC 60320 C14 and IEC 60320 C13 configurations, IEC 60320 C6 and IEC 60320 C5 configurations, IEC 60320 C8 and IEC 60320 C7 configurations or combinations thereof.

18. (canceled)

19. (canceled)

20. The power supply plug adapter of claim 14 further comprising:
a ground conductor subassembly placed inside the interior cavity of the adapter top housing between the live conductor subassembly and the neutral conductor subassembly, said ground conductor subassembly comprised of:
a male cord-end connector ground conductor pin;
a ground conductor springform having a female cord-end connector ground conductor at a ground conductor springform first end, a crimp area on the ground conductor springform at a ground conductor springform second end opposite the ground conductor springform first end, and a plurality of receptacles that fit mains plug ground conductors, said plurality of receptacles being located between the first end and the second end of the ground conductor springform;
wherein said adapter bottom housing being placed under the top housing with the three subassemblies comprised of the ground conductor subassembly, the live conductor subassembly and the neutral conductor subassembly inside the cavity making a completed monolithic unit compromised of a bottom housing and a top housing.

21. A power supply splitter, the splitter comprising:
a first end and a second end;
the first end suitable for receiving power from at least one power cord;
the second end having a female cord-end connector encased within an insulation forming a male output at the second end suitable for interfacing with a laptop power brick; and
at least one mains electrically interconnected between said first end and said second end.

22. The splitter of claim 22, wherein said first end further comprises a male cord-end connector encased within an insulation forming a female input suitable for receiving power from at least one power cord;

23. The splitter of claim 22 wherein said at least one receptacle is a mains receptacle which meets the NEMA 5-15R configuration.

24. The splitter of claim 22 wherein said first and second end meets the IEC 60320 C14 and IEC 60320 C13 configurations, IEC 60320 C6 and IEC 60320 C5 configurations, IEC 60320 C8 and IEC 60320 C7 configurations, or combinations thereof.
